(19) United States
(12) Patent Application Publication
(10) Pub. No.: US 2024/0413522 A1
(43) Pub. Date: Dec. 12, 2024

(54) ANTENNA AND MOBILE COMMUNICATION BASE STATION

(71) Applicant: Telefonaktiebolaget LM Ericsson (publ), Stockholm (SE)

(72) Inventors: Maximilian Göttl, Frasdorf (DE); Christoph Staita, Oberaudorf (DE); Markus Mohr, Rosenheim (DE); Mathias Markof, Baunach (DE); Stefan Weber, Söchtenau (DE)

(21) Appl. No.: 18/700,436

(22) PCT Filed: Oct. 13, 2021
(86) PCT No.: PCT/EP2021/078331

§ 371 Date: Apr. 11, 2024

(51) Int. Cl. H01Q 1/24; H01Q 1/42; H01Q 5/45; H01Q 19/10; H01Q 21/06

(52) U.S. Cl. CPC H01Q 1/246; H01Q 5/45; H01Q 19/104; H01Q 21/062; H01Q 1/42

(57) ABSTRACT

An antenna, in particular for a mobile communication base station, has first radiators for a first frequency range and a frame, wherein the frame defines at least one window for receiving at least one insert and the first radiators are mounted to the frame such that the first radiators lie at least partially directly above the window in a direction perpendicular to the frame Further, a mobile communication base station is shown.

### TECHNICAL FIELD

The invention concerns an antenna as well as a mobile communication base station having an antenna.

### BACKGROUND

The requirements for antennas for base stations for radio frequency cellular communication rise constantly, in particular with respect to the number of frequency bands covered by an antenna. Also 2-dimensional arrays are required to serve “multiple input—multiple output” services, known as MIMO. Thus, multi-band antennas are commonly used. In multi-band antennas, two or more types of radiators have to be arranged in respective arrays using as little space as possible together with appropriate feeding networks. Examples for such antennas are, for example, described in WO 2016/015835 A1, U.S. Pat. No. 10,008,768 B2 and U.S. Pat. No. 10,122,077 B2.

These antennas are highly integrated and specific solutions that are complex to manufacture at high costs.

### SUMMARY

It is thus the object of the invention to provide a multi-band antenna as well as a mobile communication base station, that is modular and has low manufacturing costs.

For this purpose, an antenna, in particular for a mobile communication base station, is provided. The antenna comprises first radiators for a first frequency range and a frame, wherein the frame defines at least one window for receiving at least one insert and the first radiators are mounted to the frame such that the first radiators lie at least partially directly above the window in a direction perpendicular to the frame.

By providing radiators above the windows for inserts carrying further radiators for different frequency ranges, an antenna with interleaved antenna arrays can be achieved at low costs, as the insert can be manufactured separately. Further, the inserts are exchangeable leading to modular antenna.

In particular, within this disclosure, the term “directly above” is understood, that in a top view along the direction perpendicular to the frame, the first radiator and the window overlap at least partly.

The first radiator may be arranged in an array.

In an embodiment, the first radiators have a center of gravity lying directly above the window in a direction perpendicular to the frame, the first radiators have a center of the radiating structures, e.g. dipoles, of the first radiators lying directly above the window in a direction perpendicular to the frame, the first radiators lie directly above the window in a direction perpendicular to the frame with at least 50%, preferably 70%, more preferably 80% of their area, and/or the first radiators lie fully directly above the window in a direction perpendicular to the frame. These specifications are in particular valid for each one of the first radiators separately. This way, the size of the antenna can be reduced further.

For example, the area of a radiator is to be understood as the area of the smallest rectangle or circle encompassing all of the radiating parts (e.g. diploes) of the radiator as seen in a top view perpendicular to the frame.

In an aspect, the distance in the direction perpendicular to the frame between the first radiators and a reflector of the antenna corresponds to a quarter of a wavelength of the average wavelength of the first frequency range so that the inserts are used as part of the reflector.

For a simple construction, the frame may comprise two parallel stringers extending in a longitudinal direction, wherein the at least one window is located between the stringers, in particular wherein the first radiators are attached to the stringers.

In the transverse direction, the first radiators may be equally spaced. For example, the first radiators associated with the two stringers are directly opposite one another.

For a very stable construction, the frame comprises at least two bridges connecting the stringers in a transverse direction of the frame, wherein the at least one window is surrounded by the stringers and adjacent ones of the at least two bridges.

In an embodiment, the antenna comprises at least one support structure extending from the frame and being attached to at least one of the first radiators for supporting the at least one of the first radiators, in particular wherein the at least one support structure extends from the stringers. Using the support structures, the first radiators can be securely fixed in their place above the windows.

In order to connect the first radiators electrically, the support structure comprises a feeding structure for the first radiators, in particular wherein the feeding structure is connected the dipoles of the first radiators outside of the center of the dipoles of the radiators.

The center of the dipoles may be seen in a top view along the direction perpendicular to the frame.

In an embodiment, the support structure comprises cantilevers, wherein each one of the first radiators is attached to one of the cantilevers leading to a simple yet robust design.

For example, each first radiator is connected to one of the cantilevers and vice versa.

In an aspect of the invention, the cantilever has a bent section bending inwardly and/or that the cantilever has as straight, inclined section extending in an oblique angle with respect to the transverse direction and the direction perpendicular to the frame, in particular wherein the cantilever has only one of the bent section or the straight, inclined section, leading to cantilevers that are manufactured easily.

The first radiator may be attached to the free end of bent section or straight, inclined section.

In another embodiment, the cantilever has a first section and a second section, wherein the first section extends from the frame predominantly, in particular entirely perpendicularly to the frame, and the second section extends from the first section predominantly, in particular entirely parallel to the frame. This construction increases the space below the first radiators which can be used for second and third radiators.

For example, the corresponding first radiator is attached to the second section, in particular wherein the corresponding first radiator is attached to the second section at the top side or the bottom side of the first radiator. Thus, the first radiators can be placed flexibly.

In an embodiment, the antenna comprises a main radome, the radome having a first section enclosing the frame and the first radiators on the top side of the first radiators protecting the first radiators from adverse environmental conditions.

For example, the main radome creates an interior volume comprising the first radiators, in particular wherein the interior volume is closed by the insert or is fully sealed from the outside. The main radome may be attached to the frame and/or is designed to fully accommodate the frame.

To increase the protection, the main radome may have a second section extending between the window and the first radiators on the bottom side of the first radiators, in particular wherein a portion of the second section is spaced apart from the windows in the direction perpendicular to the frame forming a receptacle for the insert.

In an embodiment, the antenna comprises at least one insert, wherein the insert comprises a base and second radiators for a second frequency range mounted to the base, wherein the insert, in particular the base, is located in the at least one window of the frame. This way, the modularity is increased further.

The second radiations are arranged in an array.

The upper surface of the frame and the bottom surface of the inserts may form a common reflector of the antenna, which may operate as a reflector for the radiators of the first frequency range and for the radiators of the second frequency range.

It is possible that third radiators for a third frequency range or even more radiators for other frequency ranges may be mounted on different ones of the inserts. The features and advantages mentioned with respect to the second radiators also apply to third radiators or other further radiators.

To reduce the size of the antenna further, the second radiators may be located in the direction perpendicular to the frame between the first radiators and the window of the frame.

In an aspect, the insert comprises an auxiliary radome enclosing the base and the second radiators on the top side of the second radiators, thus protecting the second radiators from adverse environmental conditions.

For example, the auxiliary radome creates an interior volume comprising the first radiators, in particular wherein the interior volume is closed by the insert or is fully sealed from the outside.

In an embodiment, the insert comprises an electronic component, in particular an amplifier and/or transceiver, connected to the second radiators, thus simplifying the connections to a feeding network.

In another embodiment, the distance between the frame and the body of the inserts in the transverse direction and/or the longitudinal direction is smaller than 1/10, in particular smaller than 1/20 of the average wavelength of the first frequency range and/or the frame and the body of the inserts have an overlap in the radiation direction of at least a quarter of the average wavelength of the first frequency range, improving the quality of the common reflector.

For above purpose, a mobile communication base station is further provided. The base station comprises an antenna as explained above, in particular wherein the base station comprises an amplifier or transceiver for the first radiators separate from the antenna.

The features and advantages discussed with respect to the antenna also apply to the base station and vice versa.

### BRIEF DESCRIPTION OF THE DRAWINGS

Further features and advantages will be apparent from the following description as well as the accompanying drawings, to which reference is made. In the drawings:

FIG. 1: shows a mobile communication base station according to the invention with an antenna according to the invention,

FIG. 2: a top view of an antenna of FIG. 1,

FIG. 3: a sectional view along line III-III of FIG. 2,

FIGS. 4, 5: top views of the frame and the inserts, respectively, of the antenna according to FIG. 1,

FIGS. 6-8: sectional views of the frame of a second, third and fourth embodiment of an antenna according to the invention, and

FIGS. 9-11: sectional views of a frame, an insert and an antenna according to a fifth embodiment of the invention.

### DETAILED DESCRIPTION

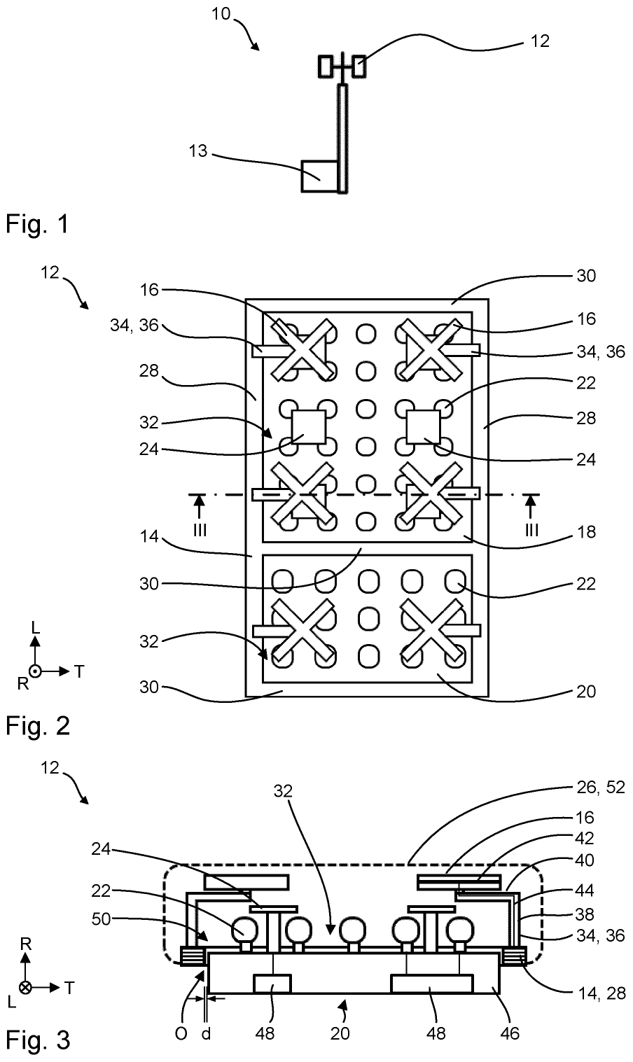

FIG. 1 shows a mobile communication base station 10 having at least one multi-band antenna 12 and an amplifier or transceiver 13.

The multi-band antenna 12 is shown in FIG. 2 in a top view and in FIG. 3 in a sectional view along line III-III of FIG. 2.

The antenna 12 comprises a frame 14 with first radiators 16 and two inserts 18, 20 with second radiators 22 as well as second radiators 22 and third radiators 24, respectively. Further, the antenna 12 comprises a main radome 26.

Only for the sake of clarity, the inserts 18, 20 are called second insert 18 and third insert 20 in the following according to the radiators 22, 24 mounted to them. Thus, as the first radiators 16 are mounted on the frame 14, no first insert exists.

The first radiators 16, the second radiators 22 and the third radiators 24 are designed to transmit and receive radiofrequency radiation in a first, second or third frequency range, respectively.

The frequencies of the first frequency range are lower than the frequencies of the third frequency range. The frequencies of the third frequency range are lower than the frequencies of the second frequency range.

For example, the first frequency range has a range of 698 to 960 MHZ, the third frequency range has a range of 1.695 to 2.690 GHz and the second frequency range has a range of 3.300 to 4.200 GHz.

The amplifier or transceiver 13 of the base station 10 is designed for the first radiators 16. Thus, the first radiators 16 are connected to the amplifier or transceiver 13 electrically, in particular by a feeding cable.

For the ease of reference, the frame 14 of the antenna 12 extends in a transverse direction T and a longitudinal direction L of the antenna 12. Further, the direction perpendicular to the frame 14 is called radiation direction R in the following, even though the actual direction of radiation may differ from the strictly perpendicular direction.

The longitudinal direction L as well as the transverse direction T are in particular orthogonal to the radiation direction R of the antenna 12.

The terms “top”, “bottom”, “up”, “down”, “above”, “below”, or the like are used with reference to the radiation direction R of the antenna 12 and the drawings, but not to an orientation of the antenna 12 when mounted in the base station 10.

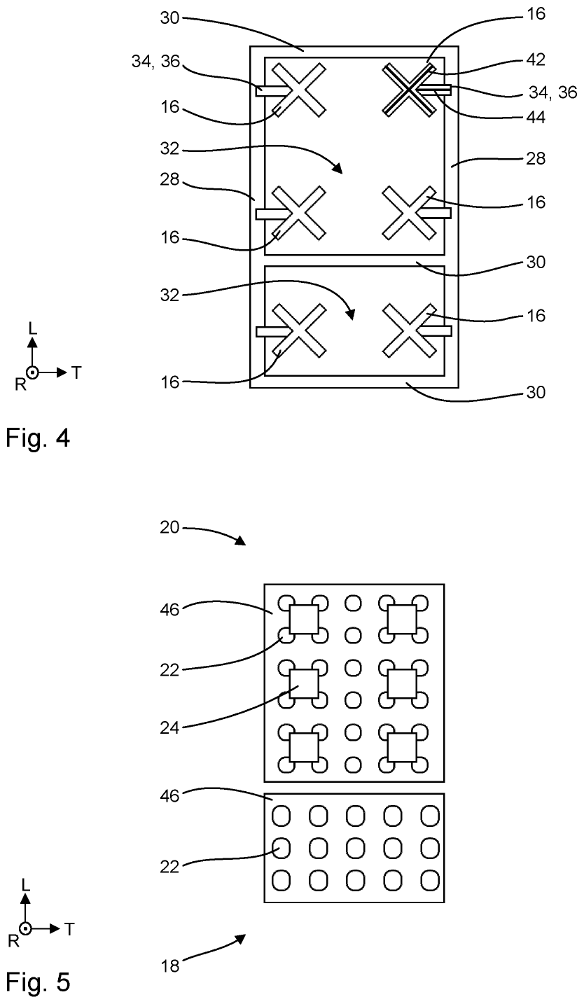

FIG. 4 shows the frame 14 without inserts 18, 20 in a top view.

The frame 14 comprises two stringers 28 extending in the longitudinal direction L and three bridges 30 extending in the transverse direction T.

The stringers 28 and the bridges 30 may or may not be separate parts from one another.

The stringers 28 are parallel to one another and at each of the ends in the longitudinal direction L, one of the bridges 30 is provided, connecting the two stringers 28.

The third bridge 30 is provided between the ends in the longitudinal direction L and also connect the stringers 28.

Thus, the stringers 28 and the bridges 30 surround two volumes, called windows 32 in the following.

The windows 32 extend in the transverse direction T between the two stringers 28 and in the longitudinal direction L between the third bridge 30 and the respective one of the bridges 30 at the ends of the stringers 28.

Thus, the frame 14 defines two windows 32, namely a first window 32 and a second window 32.

The upper surface of the frame 14, namely of the stringers 28 and the bridges 30, is a reflector surface. Thus, the windows 32 can also be seen as openings in the reflector surface.

The first radiators 16 are dual polarized radiators in the shown embodiment and have a cross shaped contour as seen in a top view, for example in FIG. 4.

The center of gravity of the first radiators 16 lies in the middle of the cross shaped contour as seen in a top view.

Further, the first radiators 16 have radiating structures of dipoles 42 extending across the first radiators 16. The dipoles 42 in total also have a center, for example the center of area as seen in a top view.

For example, the area of a radiator 16 is to be understood as the area of the smallest rectangle or circle encompassing all the radiating parts (e.g. diploes 42) of the radiator 16 as seen in a top view perpendicular to the frame 14.

The first radiators 16 are attached to the stringers 28 by a support structure 34 of the antenna 12.

In the shown embodiment, the support structure 34 comprises several cantilevers 36 and a feeding structure 44.

For example, for each one of the first radiators 16 a cantilever 36 is provided so that each one of the first radiators 16 is attached to the frame 14 by a separate one of the cantilevers 36.

In the embodiment shown in FIGS. 3 and 4, the cantilever 36 has a first section 38 and a second section 40.

The first section 38 is attached to the stringer 28 and extends perpendicularly from the frame 14 in the radiation direction R.

The second section 40 extends from the free end of the first section, i.e. the end of the first section 38 not attached to the frame 14.

The second section 40 extends parallel to the frame 14 in the transverse direction T inwards, i.e. towards the opposite stringer 28.

At the free end of the second section 40, i.e. the end of the second section 40 not attached to the first section 38, the first radiator 16 is attached to the second section 40.

As shown in FIG. 3, the second section 40 attaches to the bottom side of the corresponding first radiator 16, for example below the center of gravity of the first radiator 16.

The structure 44 comprises for example conductors attached to the cantilevers 36.

The feeding structure 44 is electrically, in particular galvanically connected to the dipoles 42 of the corresponding first radiators 16 to feed and receive radiofrequency signals to and from the first radiators 16.

On the other hand, the feeding structure 44 is electrically, in particular galvanically, connected to the amplifier or transceiver 13, for example at least in parts by a coaxial cable. This may be realized via a passive combining network, which has an input, which is then connected to the amplifier or transceiver 13 in the base station 10.

The connection between the feeding structure 44 and the dipoles 42 of the radiator 16 may be at the center of the dipoles 42 of the corresponding first radiator 16 or outside of the center of the dipoles 42 of the corresponding first radiators 16.

The dipoles 42 may comprise one or more conductive stubs or different conductive structures consisting of multiple conductive parts, for example as a so called vector dipole.

As can be seen in FIG. 4, the first radiators 16 are mounted to the frame 14 by the support structure 34 such that they are positioned directly above the windows 32.

In other words, seen in a top view, the area of the windows 32 and the area of the first radiators 16 overlap.

In particular, the center of gravity of the first radiators 16 and or the center of the dipoles 42 of the first radiators 16 light directly above the window 32.

In the shown embodiment, the area of the first radiators 16 lies entirely directly above the window 32, e.g. in the top view of FIG. 4, the area of the radiators 16 overlaps entirely with the area of the windows 32.

It is also conceivable, that only 50%, preferably 70%, more preferably 80% of the area of the first radiators 16 lies directly above the window 32.

Further, the first radiators 16 are arranged in an array, so that in the longitudinal direction L the first radiators 16 and thus the cantilevers 36 are equally spaced.

The inserts 18, 20 are shown in FIG. 5 without the frame 14 in a top view.

The inserts 18, 20 comprise a base 46 to which the second radiators 22 and/or the third radiators 24 are attached.

In the embodiment shown in FIG. 5, the second insert 18 comprises second radiators 22 and the third insert 20 comprises second radiators 22 as well as third radiators 24.

The second radiators 22 and the third radiators 24 are arranged in an array as known in the art.

The outer contour of the base 46 of the inserts 18, 20 corresponds to the contours of the respective windows 32 in which the respective insert 18, 20 is inserted.

The inserts 18, 20 may also have one or more electronic components 48, for example attached to the base 46.

The electronic components 48 may be a transceiver comprising at least one transmit amplifier and at least one receive amplifier. The transceiver is electrically connected to the second radiators 22 or the third radiators 24, respectively, in particular by conductors.

The electronic component 48 may be connected to the bottom side of the base 46.

As can be seen in FIG. 3, the third insert 20 comprises two electronic components 48, one attached to the second radiators 22, the other one electrically connected to the third radiators 24.

The base 46 of each of the inserts 18, 20 also have an upper surface being a reflector surface.

The rear side of the base 46 may comprise cooling fins, which realizes the heat dissipation for the electronic components. The insert 18, 20 therefore also may have a gasket between the radome 26 and the insert 18, 20.

When the inserts 18, 20 are inserted in the windows 32 of the frame 14, as can be seen in FIG. 3, the reflector surface of the frame 14 and the reflector surfaces of the inserts 18, 20 form the reflector 50 of the antenna 12.

To this end, the base 46 of the inserts 18, 20 and the frame 14 may be capacitively connected.

The reflector surfaces of the inserts 18, 20 and the reflector surface of the frame 14 do not necessarily have to be perfectly aligned with one another. It is possible that the reflector surfaces of the inserts 18, 20 and the reflector surface of the frame 14 are offset by less than a tenth of a wavelength of the average wavelength of the first frequency range.

The reflector 50 is thus a common reflector for the first radiators 16, the second radiators 22 and the third radiators 24. The distance between the reflector 50 and the first, second and third radiators 16, 22, 24 is a quarter of the wavelength of the average wavelength of the first, second and third frequency range, respectively.

The second radiators 22 and the third radiators 24 are arranged between the first radiator 16 and the frame 14, more precisely the window 32, in the radiation direction R when the inserts 18, 20 are placed in the windows 32.

FIG. 3 shows also the main radome 26. The main radome 26 comprises a first section 52 associated with the upper side of the frame 14. The first section 52 extends, for example, on the upper side of the first radiators 16 and surrounds the first radiators 16 also in the transverse direction T and the longitudinal direction L.

In the shown embodiment, the first section 52 is attached directly to the frame 14, in particular the stringers 28. It is also conceivable, that the first section 52 of the main radome 26 is attached to the frame 14 by other means.

The first section 52 of the main radome 26 and the frame 14 define an interior volume that is fully closed, except for the windows 32.

In the windows 32, the bases 46 of the inserts 18, 20 are located so that the windows 32 are also closed as well.

Thus, the interior volume is sealed from the outside so that the main radome 26 provides ingress protection.

Thus, by placing the first radiators 16 above the windows, and with that above the inserts 18, 20 and thus the array of the second and third radiators 22, 24, the array of the radiators 16, 22, 24 are interleaved. Thus, a very compact multiband antenna can be achieved.

Further, by providing the main radome 26, the radiators 16, 22, 24 can be protected from environmental influences.

Further, in the transverse direction T two of the first radiators 16 form a pair of radiators directly opposite to one another and mounted to different stringers 28.

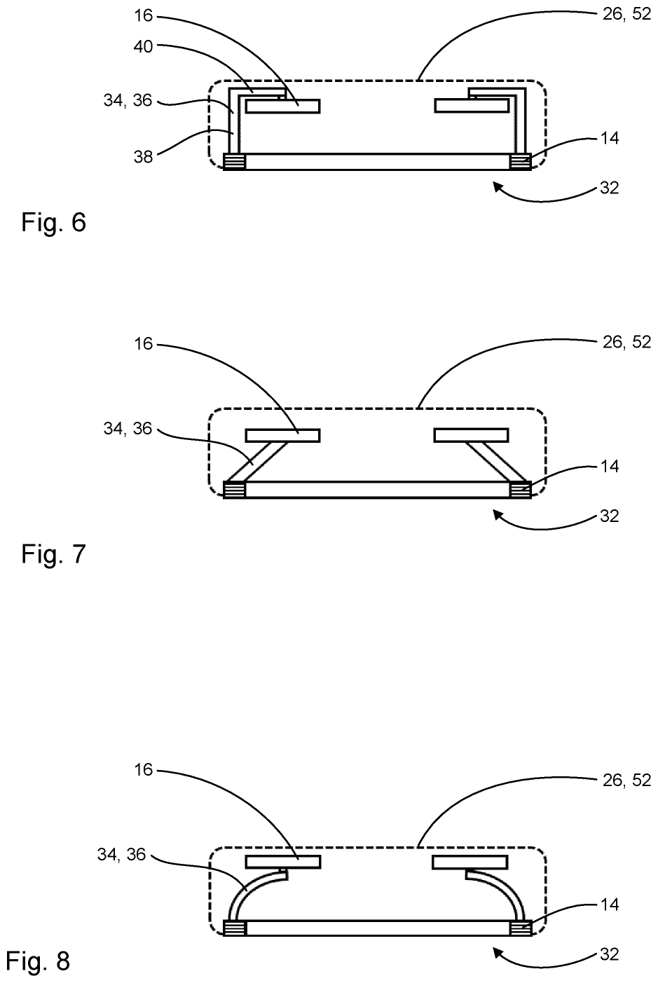

Further embodiments of the invention are shown in FIGS. 6 to 11 that correspond substantially to the embodiment described above so that only the differences are discussed in the following. The same and functionally the same elements are labeled with the same reference numbers.

FIG. 6 shows a sectional view corresponding to that of FIG. 3 without the inserts.

This second embodiment differs from the first embodiment only in the support structure 34.

In this second embodiment, the first section 38 of the cantilever 36 is longer, and the second section 40 of the cantilever 36 extends above the first radiators 16.

Thus, the first radiators 16 are attached to the second section 40 of the cantilever 36 at their top sides.

FIG. 7 shows a cross-section of a frame similar to that of FIG. 6, but of a third embodiment.

The third embodiment according to FIG. 7 differs from the first embodiment only in the support structure 34.

In the third embodiment, the cantilevers 36 have only a single section, being a straight and inclined section.

The straight, inclined section is inclined inwardly and at an oblique angle with respect to the transverse direction T and the radiation direction R.

At the first end of the straight, inclined section of the cantilever 36, the first radiator 16 is attached.

FIG. 8 shows a forth embodiment of the antenna 12, namely a sectional view of the frame corresponding to that of FIG. 3.

In this fourth embodiment, the support structure 34 differs from that of the first embodiment.

The cantilever 36 has only one section, namely a bend section.

The bent section extends from the frame 14 perpendicularly to the frame 14 and then bends inwardly. The free end of the section of the cantilever 36 extends then substantially in the transverse direction T.

At this free end the first radiator 16 is attached.

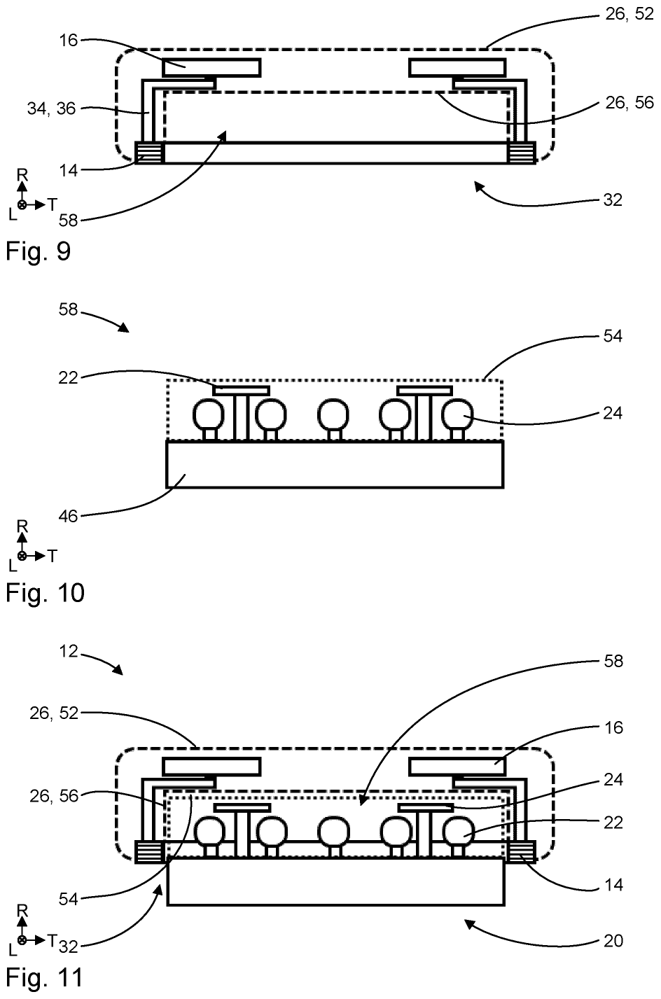

FIGS. 9 to 11 show a fifth embodiment of the antenna 12 according to the invention.

This embodiment differs from the first embodiment with respect to the main radome 26 and an auxiliary radome 54 at the inserts 18, 20.

As can be seen in FIG. 9, which shows a cross-section of the frame 14 only, the main radome 26 comprises the first section 52 as explained with respect to the first embodiment and also a second section 56.

The second section 56 extends in the region of the window 32.

More precisely, the second section 56 extends on the bottom side of the first radiators 16 from one of the stringers 28 to the other.

Further, the second section 56 has portions extending in the radiation direction R at the edges of the window 32 and a portion extending horizontally in the longitudinal and transverse direction.

The portion extending in the transversal and longitudinal direction is spaced apart from the window 32 so that a receptacle 58 is formed which is accessible via the window 32.

With this second section 56 of the main radome 26, the inner volume defined by the main radome 26 is fully sealed with respect to the environment. Thus, the first radiators 16 are very well protected from the environment. At the same time, due to the receptacle 58 formed by the second section 56, the modularity of the antenna, i.e. the interchangeability of the inserts 18, 20 is maintained.

FIG. 10 shows the third insert 20 of the fifth embodiment in a sectional view. The features discussed in the following of course also apply to the second insert 18.

The third insert 20 has an auxiliary radome 54 which covers the second radiators 22 and the third radiators 24.

As can be seen, the auxiliary radome 54 is attached to the base 46 and surrounds the second and third radiators 22, 24 in the longitudinal and transverse direction completely.

Thus, an interior volume formed by the auxiliary radome 54 is closed and fully sealed from the environment, therefore protecting the second and the third radiators 22, 24 from external influences, like harsh weather conditions.

At the same time, the contour of the auxiliary radome 54 is complementary to the contour of the second section 56 of the main radome 26 so that the inserts 18, 20 can still be inserted into the receptacle 58 of the frame as can be seen in FIG. 11.

Of course, the features of the various embodiments as explained above can be combined with each other. In particular, in the fifth embodiment the various designs of the cantilevers 36 according to the second, third and fourth embodiment can easily be applied. In this case, the contour of the second section 56 of the main radome 26 and also of the auxiliary radome 54 of the inserts 18, 20 are adapted accordingly.

To this end, the distance d (FIG. 3) between the frame 14 and the body 46 of the inserts 18, 20 in the transverse direction T and/or the longitudinal direction L is chosen such that the frame 14 and the body 46 of the respective insert 18, 20 will have a large capacitive coupling to improve the functionality of the body 46 as the common reflector also for the first radiators 16. For example, this can be achieved by a distance smaller than 1/10 or 1/20 of the average wavelength of the first frequency range.

Also the length in the radiation direction of an overlap O (FIG. 3) of the insert 46 and the frame 14 may be preferably a quarter of the wavelength of the first frequency range. This overlap O can be enlarged, when the insert 18, 20 comprises a collar at the upper end, which overlaps the frame structure 14.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. Antenna, in particular for a mobile communication base station, comprising first radiators for a first frequency range and a frame, wherein the frame defines at least one window for receiving at least one insert and the first radiators are mounted to the frame such that the first radiators lie at least partially directly above the window in a direction perpendicular to the frame.

2. Antenna according to claim 1, characterized in that the first radiators have a center of gravity lying directly above the window in a direction perpendicular to the frame, that the first radiators have a center of the radiating structures of the first radiators lying directly above the window in a direction perpendicular to the frame, that the first radiators lie directly above the window in a direction perpendicular to the frame with at least 50%, preferably 70%, more preferably 80% of their area, and/or that the first radiators lie fully directly above the window in a direction perpendicular to the frame.

3. Antenna according to claim 1, characterized in that the distance in the direction perpendicular to the frame between the first radiators and a reflector of the antenna corresponds to a quarter of a wavelength of the average wavelength of the first frequency range.

4. Antenna according to claim 1, characterized in that the frame comprises two parallel stringers extending in a longitudinal direction (L), wherein the at least one window is located between the stringers, in particular wherein the first radiators are attached to the stringers.

5. Antenna according to claim 4, characterized in that the frame comprises at least two bridges connecting the stringers in a transverse direction (T) of the frame, wherein the at least one window is surrounded by the stringers and adjacent ones of the at least two bridges.

6. Antenna according to claim 1, characterized in that the antenna comprises at least one support structure extending from the frame and being attached to at least one of the first radiators for supporting the at least one of the first radiators, in particular wherein the at least one support structure extends from the stringers.

7. Antenna according to claim 6, characterized in that the support structure comprises a feeding structure for the first radiators, in particular wherein the feeding structure is connected to dipoles of the first radiators outside of the center of the dipoles of the radiators.

8. Antenna according to claim 6, characterized in that the support structure comprises cantilevers, wherein each one of the first radiators is attached to one of the cantilevers.

9. Antenna according to claim 8, characterized in that the cantilever has a bent section bending inwardly and/or that the cantilever has as straight, inclined section extending in an oblique angle with respect to the transverse direction (T) and the direction perpendicular to the frame, in particular wherein the cantilever has only one of the bent section or the straight, inclined section.

10. Antenna according to claim 8, characterized in that the cantilever has a first section and a second section, wherein the first section extends from the frame predominantly, in particular entirely perpendicularly to the frame, and the second section extends from the first section predominantly, in particular entirely parallel to the frame.

11. Antenna according to claim 10, characterized in that the corresponding first radiator is attached to the second section, in particular wherein the corresponding first radiator is attached to the second section at the top side or the bottom side of the first radiator.

12. Antenna according to claim 1, characterized in that the antenna comprises a main radome, the main radome having a first section enclosing the frame and the first radiators on the top side of the first radiators.

13. Antenna according to claim 12, characterized in that the main radome has a second section extending between the window and the first radiators on the bottom side of the first radiators, in particular wherein a portion of the second section is spaced apart from the windows in the direction perpendicular to the frame forming a receptacle for the insert.

14. Antenna according to claim 1, characterized in that the antenna comprises at least one insert, wherein the insert comprises a base and second radiators for a second frequency range mounted to the base, wherein the insert, in particular the base, is located in the at least one window of the frame.

15. Antenna according to claim 14, characterized in that the second radiators are located in the direction perpendicular to the frame between the first radiators and the window of the frame.

16. Antenna according to claim 14, characterized in that the insert comprises an auxiliary radome enclosing the base and the second radiators on the top side of the second radiators.

17. Antenna according to claim 14, characterized in that the insert comprises an electronic component, in particular an amplifier and/or transceiver, connected to the second radiators.

18. Antenna according to claim 1, characterized in that the distance (G) between the frame and the body of the inserts in the transverse direction (T) and/or the longitudinal direction (L) is smaller than 1/10, in particular smaller than 1/20 of the average wavelength of the first frequency range and/or that the frame and the body of the inserts have an overlap (O) in the radiation direction (R) of at least a quarter of the average wavelength of the first frequency range.

19. Mobile communication base station comprising an antenna according to claim 1, in particular wherein the base station comprises an amplifier or transceiver for the first radiators separate from an antenna the antenna comprising first radiators for a first frequency range and a frame, wherein the frame defines at least one window for receiving at least one insert and the first radiators are mounted to the frame such that the first radiators lie at least partially directly above the window in a direction perpendicular to the frame.
